(19) United States
(12) Patent Application Publication
(10) Pub. No.: US 2026/0120173 A1
(43) Pub. Date: Apr. 30, 2026

(54) AUGMENTED REALITY WITH FEEDBACK

(71) Applicant: Walmart Apollo, LLC, Bentonville, AR (US)

(72) Inventors: Todd Frey Goodyear, Encinitas, CA (US); Sivan Liberman, Tel Aviv (IL); Aaron Thurgood, Hod-Hasharon (IL); Cheryl Lynn Ainoa, San Jose, CA (US); Desirée Danielle Gabrielle Gosby, San Francisco, CA (US); Tina Lynn Milford, Bentonville, AR (US)

(73) Assignee: Walmart Apollo, LLC, Bentonville, AR (US)

(21) Appl. No.: 18/959,047

(22) Filed: Nov. 25, 2024

Related U.S. Application Data
(60) Provisional application No. 63/712,019, filed on Oct. 25, 2024.

(51) Int. Cl. H04L 67/131; G06Q 30/0601; G06T 19/00

(52) U.S. Cl. CPC G06Q 30/0643; G06Q 30/0633; G06T 19/006; G06T 2219/024

(57) ABSTRACT

Example implementations relate to creating 3D images in an interactive digital space are disclosed herein. In an example, instructions are received from a first user device to create a 3D image of the user wearing a 3D model of an item within an interactive digital space via an augmented reality viewer of the first user device. The 3D image is transmitted to a second user device that is capable of being connected to the interactive digital space via an augmented reality viewer of the second user device. Feedback regarding the 3D image is received from the second user device and the item is stored in a database for the user.

### CROSS-REFERENCE TO RELATED APPLICATIONS

This application claims priority to U.S. Provisional Patent Application No. 63/712,019, filed Oct. 25, 2024, which is incorporated by reference herein in its entirety.

### FIELD OF THE DISCLOSURE

The present disclosure generally relates to augmented reality with user feedback.

### BACKGROUND

Augmented reality (AR) has many applications, including permitting people in different locations to interact with each other in the augmented reality. This capability can enhance communication and collaboration between the people by overlaying digital information onto real world images to creating a blended experience that feels more immersive and engaging. However, AR also has many limitations, including requiring the people to be available for the AR experience at the same time in order to communicate and collaborate with each other. This synchronous nature of AR interactions can be a major drawback because it requires coordinating schedules, which can be difficult due to time zone differences, personal commitments, and varying availability. This constraint significantly reduces the flexibility and convenience of using AR for remote interactions and, therefore, limits the use of AR.

### BRIEF DESCRIPTION OF THE DRAWINGS

The figures described below depict various aspects of the systems, methods, and non-transitory computer readable storage media disclosed therein. It should be understood that each figure depicts an embodiment of a particular aspect of the disclosed systems, methods, and non-transitory computer readable storage media, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a front elevation view of two computer systems that are suitable for implementing an embodiment of the system disclosed in FIG. 3;

FIG. 2 illustrates a representative block diagram of an example of the elements included in the circuit boards inside a chassis of the computer systems of FIG. 1;

FIG. 3 illustrates a system for augmented reality with feedback, according to one embodiment;

FIG. 4 illustrates a flow chart for a method for augmented reality with feedback, according to one embodiment;

FIG. 5 illustrates a flow chart for a method for augmented reality with feedback, according to one embodiment;

FIG. 6 illustrates a flow chart for a method for augmented reality with feedback, according to one embodiment;

FIG. 7 illustrates a flow chart for a method for augmented reality with feedback, according to one embodiment;

FIG. 8 illustrates a user interface for an electronic device, according to one embodiment;

FIG. 9 illustrates a flow chart for a first portion of a method for augmented reality with feedback, according to one embodiment;

FIG. 10 illustrates a flow chart for a second portion of the method of FIG. 9 for augmented reality with feedback, according to one embodiment; and

FIG. 11 illustrates a flow chart for a third portion of the method of FIG. 9 for augmented reality with feedback, according to one embodiment.

The figures depict embodiments for purposes of illustration only. One skilled in the art will readily recognize from the following discussion that other embodiments of the systems, methods, and non-transitory computer-readable media storing computing instructions that are described herein can be employed without departing from the principles of the technology described herein.

### DETAILED DESCRIPTION

The present embodiments can generally relate to augmented reality, which can include virtual reality, mixed reality (e.g., blending elements of augmented reality and virtual reality), other extended realities, mirror worlds, etc. More specifically, various embodiments can include a computer-implemented method being implemented via execution of computing instructions configured to run on one or more processors and stored on one or more non-transitory computer-readable media. The method can include receiving, from a user via a first user device, instructions to create a 3-dimensional (3D) image of the user wearing a 3D model of an item within an interactive digital space via an augmented reality viewer of the first user device. The method also can include transmitting the 3D image to a second user via a second user device that is capable of being connected to the interactive digital space via an augmented reality viewer of the second user device. The method can further include receiving feedback regarding the 3D image from the second user via the second user device. The method additionally can include storing the item in a database for the user.

Other embodiments can include a non-transitory computer-readable medium storing computing instructions that, when executed on a processor, cause the processor to execute operations. The operations can comprise receiving, from a user via a first user device, instructions to create a 3D image of the user wearing a 3D model of an item within an interactive digital space via an augmented reality viewer of the first user device. The operations also can include transmitting the 3D image to a second user via a second user device that is capable of being connected to the interactive digital space via an augmented reality viewer of the second user device. The operations can further include receiving feedback regarding the 3D image from the second user via the second user device. The operations additionally can include storing the item in a database for the user.

In other embodiments, a system can be provided. The system can include one or more local or remote processors or servers, mobile devices, smart glasses including augmented reality glasses, virtual reality headsets, mixed or extended reality headsets, and/or other electronic or electrical components, which can be in wired or wireless communication with one another. For instance, in one aspect, a computer system can include one or more local or remote processors and/or associated transceivers, along with one or more local or remote non-transitory computer-readable media storing computing instructions that, when run on the one or more processors, direct the one or more processors to perform one or more operations. The operations can include receiving, from a user via a first user device, instructions to create a 3D image of the user wearing a 3D model of an item within an interactive digital space via an augmented reality viewer of the first user device. The operations also can include transmitting the 3D image to a second user via a second user device that is capable of being connected to the interactive digital space via an augmented reality viewer of the second user device. The operations further can include receiving feedback regarding the 3D image from the second user via the second user device. The operations additionally can include storing the item in a database for the user.

Advantages will become more apparent to those skilled in the art from the following description of the embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

In some embodiments, the methods, systems, and non-transitory computer readable storage media can be used to allow augmented reality to be used by two people in the same location or at different locations, and at the same time or at different times. Although the augmented reality provided by the embodiments described herein can be used in a synchronous manner between two users, the asynchronous option of these augmented reality interactions is an advantage over the synchronous requirement of other augmented reality interactions because the asynchronous option does not require coordinating schedules, which can be difficult due to time zone differences, personal commitments, and varying availability. Accordingly, the asynchronous nature can improve the flexibility and convenience of using augmented reality.

In some embodiments, the techniques described herein can provide one or more practical applications and technological improvements. The techniques described herein can provide a technical improvement to augmented reality. As a first example, traditional augmented reality used by two people to interact with each other requires the two people to coordinate their schedules to be connected to the internet at the same time, which is a technical problem that is unique to augmented reality. The techniques described herein solve this technical problem by permitting (but not requiring) asynchronous augmented reality interactions. As another example, the asynchronous option of the augmented reality interactions described herein can conserve computer system resources, thereby reducing latency and the likelihood of overloading system capacity. Accordingly, more users can use or access the system because of the asynchronous option than if the system required synchronous use by users. Therefore, the techniques described herein can provide improvements over conventional augmented reality approaches that do not perform one or more of the functions or operations described herein.

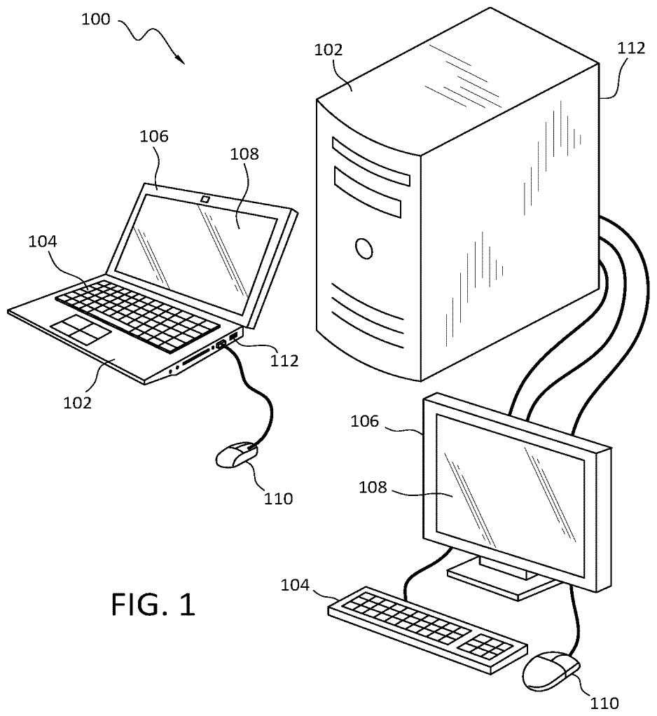

Turning to the drawings, FIG. 1 illustrates an embodiment of two different types (e.g., a laptop and a tower server) of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

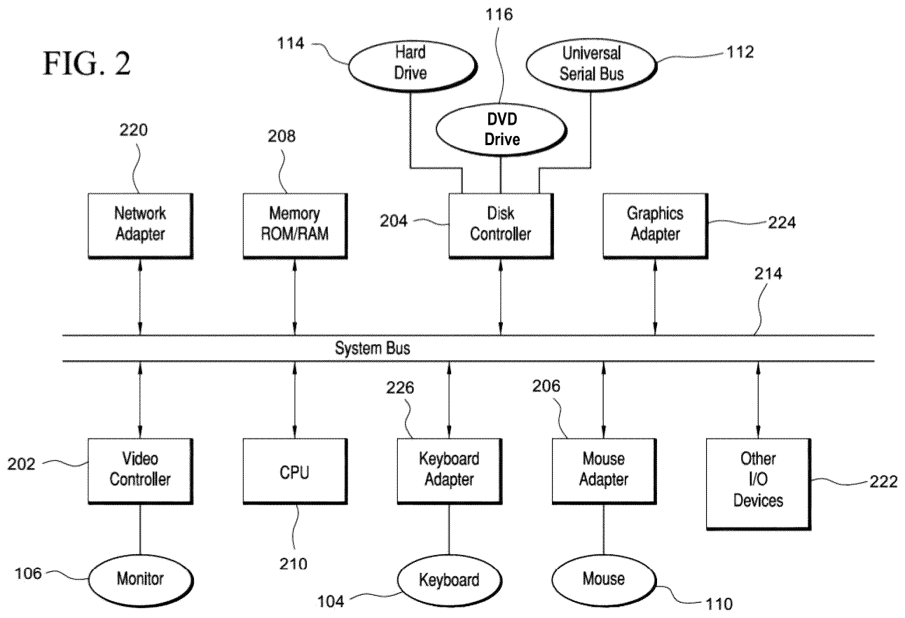

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in a CD-ROM and/or DVD drive 116 (FIG. 2) inside chassis 102 (FIG. 1) or in a detachable drive coupled to input/output port 112.

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS by The Open Group Ltd. of Reading, Berkshire in the United Kingdom, and (iv) Linux® OS by Linus Torvalds of Boston, Massachusetts, United State of America.

Further operating systems can comprise one of the following: (i) the iOS® operating system by Apple Inc. of Cupertino, California, United States of America, (ii) the Blackberry® operating system by Research In Motion (RIM) of Waterloo, Ontario, Mayada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O (input/output) devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well-known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable CD-ROM and/or DVD drive coupled to input/output port 112, on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer or a tower server in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, a virtual reality headset, augmented reality glasses, etc. In certain additional embodiments, computer system 100 can comprise an embedded system.

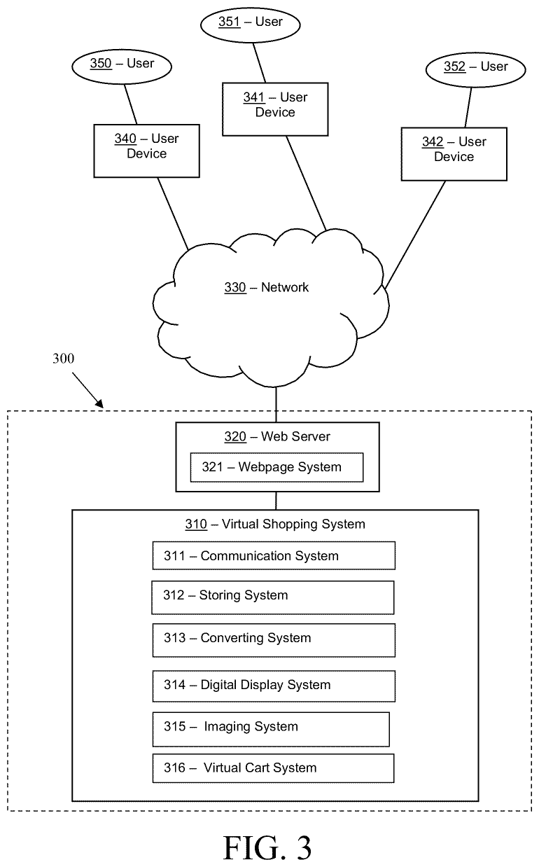

Turning ahead in the drawings, FIG. 3 illustrates a block diagram of a system 300 for augmented reality with feedback, which can provide both synchronous and asynchronous experiences, according to various embodiments. System 300 is an example, and embodiments of the system are not limited to the embodiments presented herein. The system can be employed in many different embodiments or examples not specifically depicted or described herein. In some embodiments, certain elements, modules, or systems of system 300 can perform various procedures, processes, operations, actions, and/or activities. In other embodiments, the procedures, processes, operations, actions, and/or activities can be performed by other suitable elements, modules, or systems of system 300.

Generally, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include a web server 320 and a virtual shopping system 310. In the same or different embodiments, system 300 also can include a first user device 340 of a first user 350, a second user device 341 of a second user 351, and a third user device 342 of a second user 352. In other embodiments, there are more than three user devices. Web server 320, virtual shopping system 310, first user device 340, second user device 341, and third user device 342 can each be a computer system, such as computer system 100 (FIG. 1), as described above, and can each be a single computer, a single server, or a cluster or collection of computers or servers, or a cloud of computers or servers. In another embodiment, a computer system can be a mobile device. In a further embodiment, a computer system can host web server 320, virtual shopping system 310, first user device 340, second user device 341, and third user device 342.

In some embodiments, each of web server 320, virtual shopping system 310, first user device 340, second user device 341, and third user device 342 can include modules of computing instructions (e.g., software modules) stored on non-transitory computer readable media that operate on one or more processors. In other embodiments, each of web server 320, virtual shopping system 310, first user device 340, second user device 341, and third user device 342 can be implemented in hardware, including ASICs (application specific integrated circuits) and the like. In some embodiments, web server 320 can comprise a webpage system 321, which can host a webpage and/or website for a user device. In other embodiments, webpage system 321 can, instead or in addition, host a mobile application (app) or at least a back end of an app for a user device.

In some embodiments, virtual shopping system 310 can comprise one or more systems, subsystems, modules, models, or servers (e.g., a communication system 311, a storing system 312, a converting system 313, a digital display system 314, an imaging system 315, and a virtual cart system 316, etc.). Each of communication system 311, storing system 312, converting system 313, digital display system 314, imaging system 315, and virtual cart system 316 can be implemented, at least in part, in software and/or firmware stored in or loaded on an internal or remote memory storage device(s) of virtual shopping system 310 and executed on a processor of virtual shopping system 310. In various embodiments, one or more of communication system 311, storing system 312, converting system 313, digital display system 314, imaging system 315, and virtual cart system 316 can include one or more of trained machine learning (ML) and/or artificial intelligence (AI) models (the ML/AI models). Each of communication system 311, storing system 312, converting system 313, digital display system 314, imaging system 315, and virtual cart system 316 can be a standard component or a custom component used to implement a portion of the system, method, and/or non-transitory computer-readable medium, as described herein. Additional details regarding web server 320, virtual shopping system 310, first user device 340, second user device 341, and third user device 342 are described herein.

In some embodiments, each of web server 320 or virtual shopping system 310, first user device 340, second user device 341, and third user device 342 can be in data communication, through a computer network, a telephone network, or the Internet (e.g., computer network 330) with each other. In other embodiments, web server 320 or virtual shopping system 310, first user device 340, second user device 341, and third user device 342 are in direct communication with each other using, for example, Bluetooth communication. As shown in the depicted embodiment of FIG. 3, web server 320 and virtual shopping system 310 can be in direct communication with each other without using the Internet.

In certain embodiments, web server 320 can host one or more websites and/or mobile application servers. For example, web server 320 can host a website, or provide a server that interfaces with an application (e.g., a mobile application or a web browser), to be shown or run on first user device 340, second user device 341, and third user device 342. In some embodiments, computer network 330 may be an internal network that is not open to the public can be used for communications between web server 320, virtual shopping system 310, first user device 340, second user device 341, and third user device 342.

In some embodiments, each of first user device 340, second user device 341, and third user device 342 can include one or more input devices, one or more output devices, one or more processors, and/or one or more memory storage devices. Examples of input devices can include one or more keyboards, one or more keypads, one or more pointing devices such as a computer mouse or computer mice, one or more touchscreen displays, a microphone, a camera, keyboard 104 (FIG. 1), mouse 110 (FIG. 1), etc. Examples of output devices can include one or more monitors, one or more touch screen displays, projectors, monitor 106 (FIG. 1), screen 108 (FIG. 1), etc. Other examples of output devices can include other I/O device 222 (FIG. 2), network adapter 220, wireless transmitters, wired transmitters, and the like. Examples of processors can include CPU 210 (FIG. 2), etc. Examples of memory storage devices can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. In a number of embodiments, input devices further can include one or more cameras and/or one or more microphones. In the same or different embodiments, input devices can include one or more GPS (Global Positioning System) sensor(s), one or more accelerometers, and/or one or more gyroscopes.

Input devices and output devices can be coupled to their respective first user device 340, second user device 341, and third user device 342 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple an input device and an output device to a processor and/or a memory storage device, all of a particular user device. In a similar manner, the processors and/or memory storage devices of the user devices can be local and/or remote to each other.

In certain embodiments, the user devices (e.g., first user device 340, second user device 341, and third user device 342) can be mobile devices, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, other smart jewelry, augmented-reality (AR) headsets, virtual-reality (VR) headsets, etc.), or another portable computer device with the capability to present audio and/or visual data (e.g., images, videos, music, etc.).

Mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Mayada, (iii) a Lumia® or similar product by the Nokia Corporation of Keilaniemi, Espoo, Finland, or (iv) a Galaxy™ Tab or Smartphone or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Mayada, (iii) the Android™ operating system developed by the Open Handset Alliance, or (iv) the Windows Mobile™ operating system by Microsoft Corp. of Redmond, Washington, United States of America.

Meanwhile, in some embodiments, first user device 340, second user device 341, and third user device 342 also can be configured to communicate with one or more databases and/or one or more remote servers, such as web server 320. The one or more databases can include a product database that contains products for sale on an ecommerce website, 2-dimensional (2D) and 3-dimensional (3D) models of such products, and 2D and 3D models or images of users of the website. The one or more databases additionally can include one or more of trained machine learning (ML) and/or artificial intelligence (AI) models (the ML/AI models) used in system 300, web server 320, virtual shopping system 310, first user device 340, second user device 341, and/or third user device 342. The one or more databases further can include training datasets for various ML/AI models, modules, or systems. The training datasets can be obtained from a third party, generated manually, and/or curated from historical input/output data of one or more pre-trained ML/AI models, etc.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communications between one or more of system 300, web server 320, virtual shopping system 310, first user device 340, second user device 341, and third user device 342 can be implemented using any suitable manner of wired and/or wireless communication. Accordingly, system 300, web server 320, virtual shopping system 310, first user device 340, second user device 341, and third user device 342 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). PAN protocol(s) can include Bluetooth, Zigbee, Wireless Universal Serial Bus (USB), Z-Wave, etc.; LAN and/or WAN protocol(s) can include Institute of Electrical and Electronic Engineers (IEEE) 802.3 (also known as Ethernet), IEEE 802.11 (also known as WiFi), etc.; and wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In some embodiments, communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further communication hardware can include wireless communication hardware including, for example, one or more radio transceivers, one or more infrared transceivers, etc. Additional communication hardware can include one or more networking components (e.g., modulator-demodulator components, gateway components, etc.).

In some embodiments, web server 320 and/or virtual shopping system 310 can be configured to transmit, to a user device (e.g., first user device 340, second user device 341, and third user device 342, etc.) of a user, or to a graphical user interface (e.g., a webpage, a graphical user interface of a mobile application, etc.) for display on the user device. The graphical user interface can include statistics, notices, augmented reality views, feedback, and the like. Web server 320, virtual shopping system 310, first user device 340, second user device 341, and third user device 342 can determine, by using any suitable approaches or ML/AI models, the statistics, notices, augmented reality views, feedback, and other information. Algorithms for the ML/AI models for determining the information can include decision trees, K Nearest Neighbor (KNN), neural networks, CatBoost, support vector machine, etc.

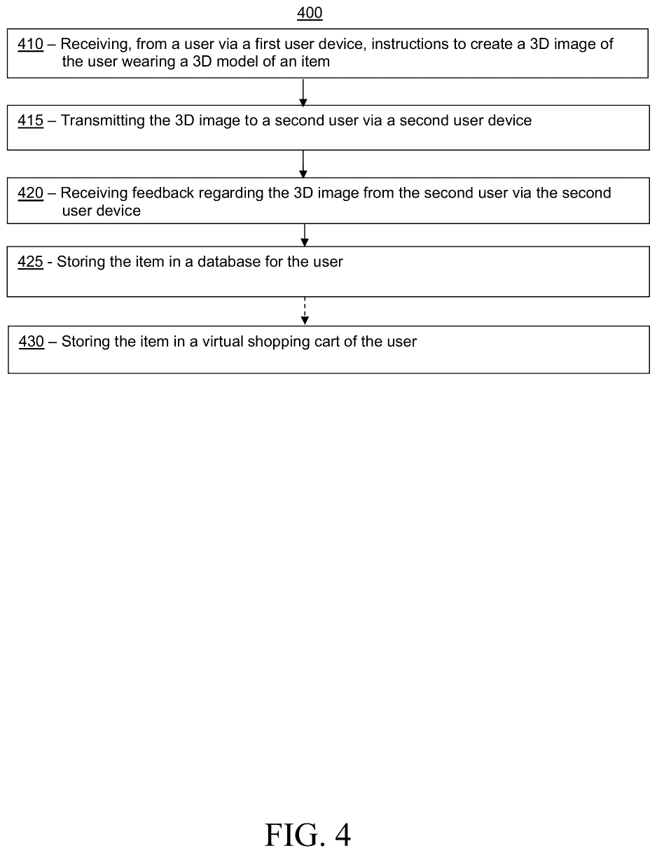

Turning ahead in the drawings, FIG. 4 illustrates a flow chart for a method 400 for augmented reality with feedback, which can provide both synchronous and asynchronous experiences, according to one embodiment. Method 400 can be implemented via execution of computing instructions configured to run on one or more processors and stored on one or more non-transitory computer-readable media, and/or via one or more ASICs. Method 400 is merely an example and is not limited to the embodiments presented herein. Method 400 can be employed in many different embodiments or examples not specifically depicted or described herein.

In some embodiments, the procedures, the processes, the operations, the actions, and/or the activities of method 400 can be performed in the order presented. In other embodiments, the procedures, the processes, the operations, the actions, and/or the activities of method 400 can be performed in any suitable order. In still other embodiments, one or more of the procedures, the processes, the operations, the actions, and/or the activities of method 400 can be combined together or skipped.

In some embodiments, system 300 (FIG. 3) (including one or more of its elements, modules, and/or systems, such as communication system 311, storing system 312, converting system 313, digital display system 314, imaging system 315, and virtual cart system 316, etc.) can be suitable to perform method 400 and/or one or more of the operations, actions, and/or activities of method 400. In these or other embodiments, one or more of the operations, actions, and/or activities of method 400 can be implemented as one or more computing instructions configured to run on one or more processors and configured to be stored on one or more non-transitory computer readable media, and/or as one or more ASICs. Such non-transitory computer readable media can be part of a computer system such as system 300 (FIG. 3), web server 320 (FIG. 3), virtual shopping system 310 (FIG. 3), first user device 340 (FIG. 3), second user device 341 (FIG. 3), and third user device 342 (FIG. 3). The processor(s) can be similar or identical to the processor(s) described above with respect to computer system 100 (FIG. 1).

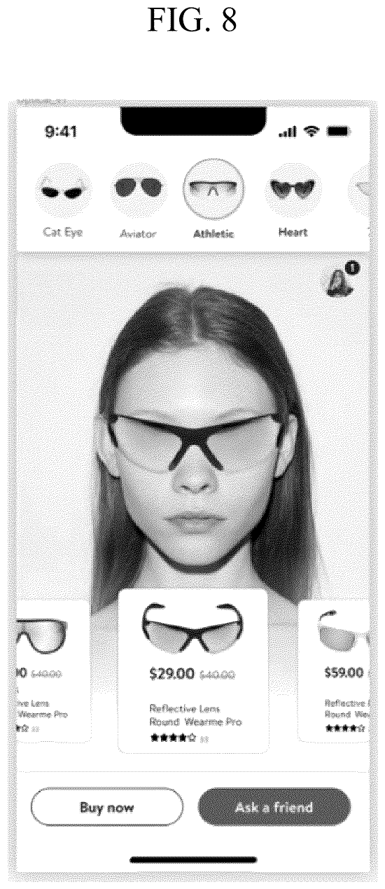

Referring to FIG. 4, in n some embodiments, method 400 can include a block 410 of receiving, from a user via a first user device, instructions to create a 3D image of the user wearing a 3D model of an item. As an example, the user can be user 350 (FIG. 3), and the first user device can be user device 340 (FIG. 3). As an illustration, the 3D image of the user wearing the 3D model of the item can be shown in FIG. 8 where the user is a woman and the item is a pair of sunglasses.

Turning back to FIG. 4, in some embodiments of block 410, the 3D image of the user wearing the 3D model of the item is shown within an interactive digital space via a viewer of the first user device. As an example, the interactive digital space can be an augmented reality, and the viewer can be an augmented reality viewer. Accordingly, in this embodiment, block 410 can include receiving, from a user via a first user device, instructions to create a 3D image of the user wearing a 3D model of an item within an interactive digital space via an augmented reality viewer of the first user device. In some embodiments, block 410 can also include creating the 3D image of the user wearing the 3D model of the item in response to the received request.

In the same or different embodiments, the 3D image can comprise one or more 3D images of the user wearing one or more items, and the 3D model can comprise one or more 3D models of one or more items or combinations of 3D models of items. In embodiments where the augmented reality comprises a virtual reality or a mixed reality, etc., then the augmented reality viewer comprises a virtual reality viewer or a mixed reality viewer, etc., respectively.

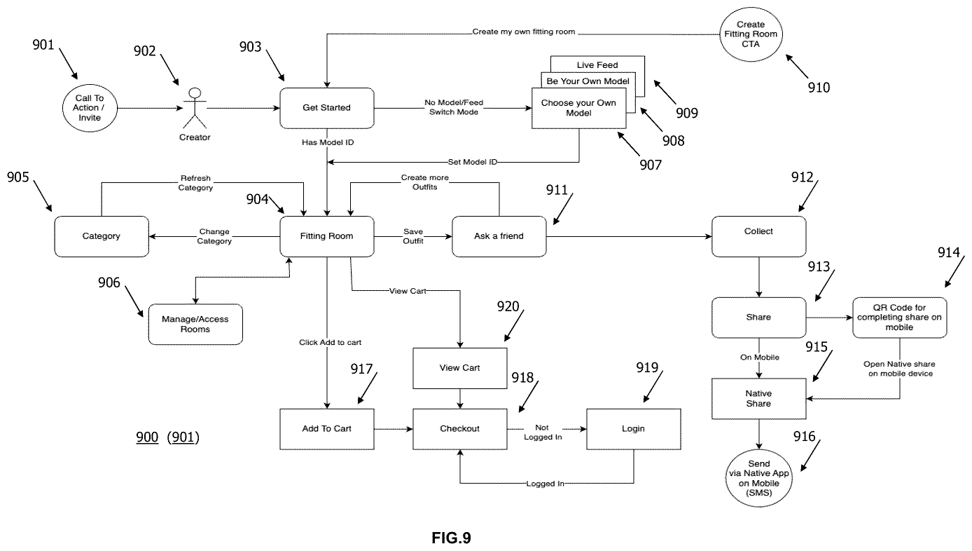

After block 410, method 400 can continue with a block 415 of transmitting the 3D image to a second user via a second user device. As an example, the second user can be user 351 (FIG. 3), and the second user device can be user device 341 (FIG. 3). In some embodiments, the transmitting of block 415 can comprise sending a text with a link to the 3D image in an augmented reality, as explained in further detail below with reference to FIGS. 9, 10, and 11. In certain embodiments, the transmitting of block 415 can be performed by virtual shopping system 310.

In some embodiments of block 415, the second user device is capable of being connected to the same interactive digital space to which the first user device is connected. For example, the interactive digital space may be hosted by virtual shopping system 310 and/or web server 320. Also, the second user device can have a viewer of the interactive digital space, and when the interactive digital space is an augmented reality, the viewer can be an augmented reality viewer. Accordingly, in this embodiment, block 415 can include transmitting the 3D image to a second user via a second user device that is capable of being connected to the interactive digital space via an augmented reality viewer of the second user device.

In some embodiments, block 415 can transmit the 3D image to multiple second users sequentially or simultaneously, each via their own respective user device that is capable of being connected to the same interactive digital space via a respective augmented reality viewer of the respective user device. For example, see the “Ask a friend” button in FIG. 8. Again, in embodiments where the augmented reality comprises a virtual reality or a mixed reality, etc., then the augmented reality viewer comprises a virtual reality viewer or a mixed reality viewer, etc., respectively.

Turning back to FIG. 4, after block 415, method 400 can continue with a block 420 of receiving feedback regarding the 3D image from the second user via the second user device. As an example, the feedback can be a vote in favor of the 3D image, which means that the second user likes the item and/or the first user's wearing of the item. In some embodiments, before or after receiving the feedback in block 420, method 400 can be used to seek additional feedback from one or more other users in a similar manner to what is described with reference to blocks 415 and 420. The feedback in block 420 can be received from the second user in a synchronous manner with and/or in real-time with the transmission of the 3D image to the second user in block 415, and/or in an asynchronous manner with the transmission of the 3D image to the second user in block 415.

After block 420, method 400 can continue with a block 425 of storing the item in a database for the user. In some embodiments, the item can be stored in the database so that the item can be added to a virtual shopping cart for the user. In some embodiments, block 425 is performed before or simultaneously with block 420. In embodiments where block 410 receives instructions to create one or more 3D images of the user wearing 3D models of more than one item, then block 425 can comprise storing at least one of the more than one item in the database for the user.

After block 425, method 400 can continue with an optional block 430 of storing the item in a virtual shopping cart of the user. In embodiments where block 410 receives instructions to create one or more 3D images of the user wearing 3D models of more than one item and where block 425 stores at least one of the more than one item in the database for the user, then block 430 can comprise storing the at least one of the more than one item in the virtual shopping cart for the user. Additional details of method 400 are explained with reference to FIGS. 9, 10, and 11, below.

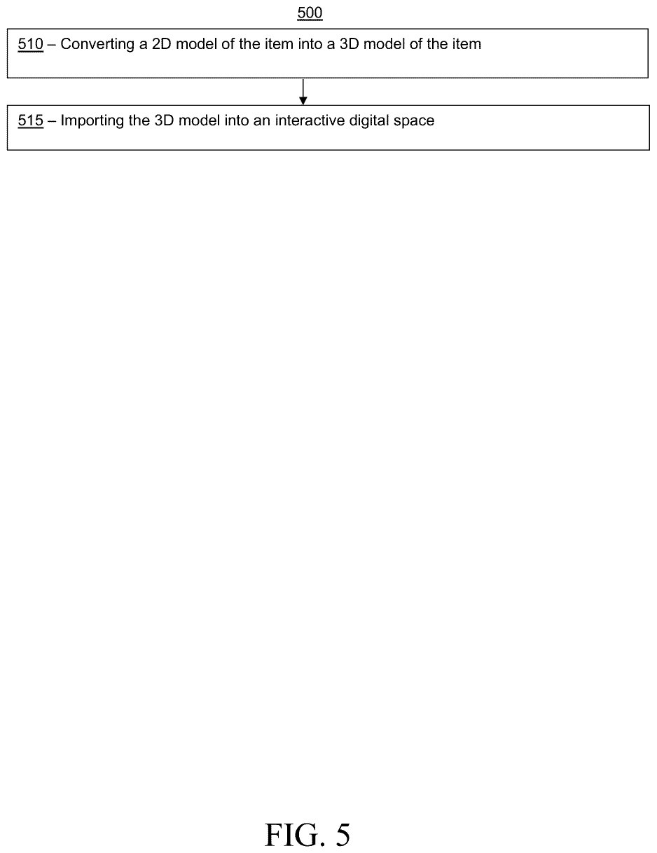

Turning further ahead in the drawings, FIG. 5 illustrates a flow chart for a method 500 for augmented reality with feedback, which can provide both synchronous and asynchronous experiences, according to one embodiment. Method 500 can be implemented via execution of computing instructions configured to run on one or more processors and stored on one or more non-transitory computer-readable media, and/or via one or more ASICs. Method 500 is merely an example and is not limited to the embodiments presented herein. Method 500 can be employed in many different embodiments or examples not specifically depicted or described herein.

In some embodiments, the procedures, the processes, the operations, the actions, and/or the activities of method 500 can be performed in the order presented. In other embodiments, the procedures, the processes, the operations, the actions, and/or the activities of method 500 can be performed in any suitable order. In still other embodiments, one or more of the procedures, the processes, the operations, the actions, and/or the activities of method 500 can be combined together or skipped.

In some embodiments, system 300 (FIG. 3) (including one or more of its elements, modules, and/or systems, such as communication system 311, storing system 312, converting system 313, digital display system 314, imaging system 315, and virtual cart system 316, etc.) can be suitable to perform method 500 and/or one or more of the operations, actions, and/or activities of method 500. In these or other embodiments, one or more of the operations, actions, and/or activities of method 500 can be implemented as one or more computing instructions configured to run on one or more processors and configured to be stored on one or more non-transitory computer readable media, and/or as one or more ASICs. Such non-transitory computer readable media can be part of a computer system such as system 300 (FIG. 3), web server 320 (FIG. 3), virtual shopping system 310 (FIG. 3), first user device 340 (FIG. 3), second user device 341 (FIG. 3), and third user device 342 (FIG. 3). The processor(s) can be similar or identical to the processor(s) described above with respect to computer system 100 (FIG. 1).

Referring to FIG. 5, in some embodiments, method 500 can include a block 510 of converting a 2D model of the item into the 3D model of the item. After block 510, method 500 can include a block 515 of importing the 3D model into the interactive digital space to be displayed to the user via the augmented reality viewer of the first user device. As an example, method 500 can be performed before block 410 (FIG. 4) of method 400 (FIG. 4). Moreover, the interactive digital space, the augmented reality viewer, and the first user device of block 515 can be the same as the interactive digital space, the augmented reality viewer, and the first user device of block 410 (FIG. 4) in method 400 (FIG. 4). Further details of method 500 are explained with reference to FIGS. 9, 10, and 11, below.

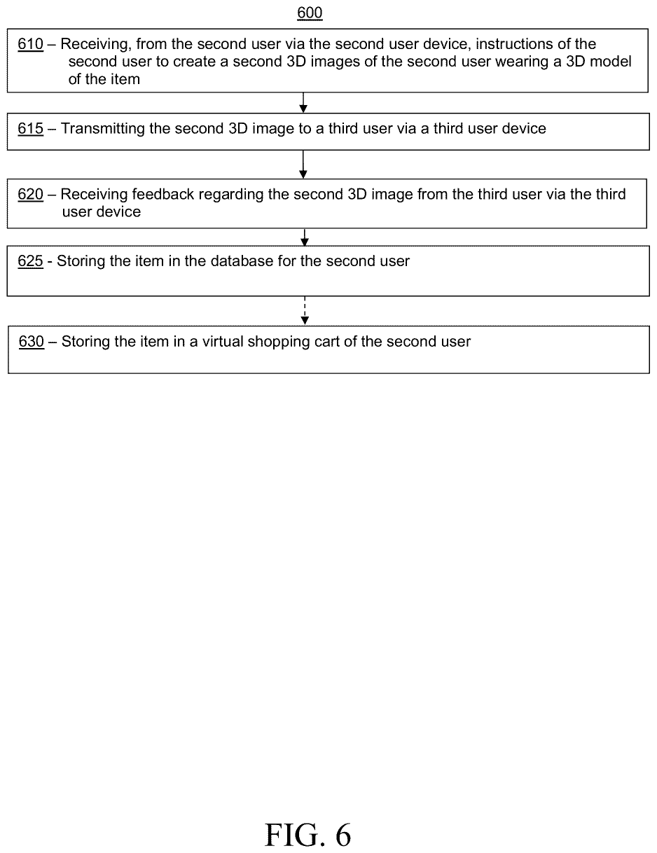

Turning further ahead in the drawings, FIG. 6 illustrates a flow chart for a method 600 for augmented reality with feedback, which can provide both synchronous and asynchronous experiences, according to one embodiment. As explained below, method 600 can be similar to method 400 (FIG. 4) in certain aspects, and can be performed after method 400 (FIG. 4) is completed or can be begin after method 400 (FIG. 4) starts but before method 400 (FIG. 4) finishes. Method 600 can be implemented via execution of computing instructions configured to run on one or more processors and stored on one or more non-transitory computer-readable media, and/or via one or more ASICs. Method 600 is merely an example and is not limited to the embodiments presented herein. Method 600 can be employed in many different embodiments or examples not specifically depicted or described herein.

In some embodiments, the procedures, the processes, the operations, the actions, and/or the activities of method 600 can be performed in the order presented. In other embodiments, the procedures, the processes, the operations, the actions, and/or the activities of method 600 can be performed in any suitable order. In still other embodiments, one or more of the procedures, the processes, the operations, the actions, and/or the activities of method 600 can be combined together or skipped.

In some embodiments, system 300 (FIG. 3) (including one or more of its elements, modules, and/or systems, such as communication system 311, storing system 312, converting system 313, digital display system 314, imaging system 315, and virtual cart system 316, etc.) can be suitable to perform method 600 and/or one or more of the operations, actions, and/or activities of method 600. In these or other embodiments, one or more of the operations, actions, and/or activities of method 600 can be implemented as one or more computing instructions configured to run on one or more processors and configured to be stored on one or more non-transitory computer readable media, and/or as one or more ASICs. Such non-transitory computer readable media can be part of a computer system such as system 300 (FIG. 3), web server 320 (FIG. 3), virtual shopping system 310 (FIG. 3), first user device 340 (FIG. 3), second user device 341 (FIG. 3), and third user device 342 (FIG. 3). The processor(s) can be similar or identical to the processor(s) described above with respect to computer system 100 (FIG. 1).

Referring to FIG. 6, in some embodiments, method 600 can include a block 610 of receiving, from the second user via the second user device, instructions of the second user to create a second 3D images of the second user wearing a 3D model of the item. Block 610 can be similar to block 410 (FIG. 4) in method 400 (FIG. 4) in certain aspects. Accordingly, as an example, the second user can be user 351 (FIG. 3), and the second user device can be user device 341 (FIG. 3). In this embodiment, the second user and second user device of block 610 can be the same second user and second user device of block 415 (FIG. 4). Also in this same embodiment, block 610 and method 600, generally, can be performed after block 415 (FIG. 4) of method 400 (FIG. 4) and before block 420 (FIG. 4), block 425 (FIG. 4), or block 430 (FIG. 4) of method 400 (FIG. 4).

In some embodiments of block 610, the second 3D image of the second user wearing the 3D model of the item is shown within an interactive digital space via a viewer of the second user device. As an example, the interactive digital space can be an augmented reality, and the viewer can be an augmented reality viewer. Accordingly, in this embodiment, block 610 can include receiving, from a second user via a second user device, instructions to create a second 3D image of the second user wearing the 3D model of the item within the interactive digital space via the augmented reality viewer of the second user device. As an example, the interactive digital space of block 610 can be the same interactive digital space of block 410 (FIG. 4), and the augmented reality viewer of the second user device of block 610 can be the same augmented reality viewer of the second user device of block 415 (FIG. 4).

As an example of the implementation of block 610, the second 3D image of the second user wearing the 3D model of the item can be shown in FIG. 8 where the user is a woman and the item is the pair of sunglasses. In embodiments where block 610 of method 600 in FIG. 6 are performed after block 415 (FIG. 4) of method 400 (FIG. 4), then FIG. 8 for block 615 would be modified such that the second 3D image of the second user in block 615 would be a different 3D image of a different person than the first 3D image of the first user in block 415 (FIG. 4) and such that the 3D model of the item for block 615 and for block 415 (FIG. 4) would be the same 3D model for the same pair of sunglasses. In other words, as explained further in FIGS. 9, 10, 11, after the first user of method 400 (FIG. 4) creates an augmented reality view of the first user wearing the first item and sends the augmented reality view to the second user to view, the second user can create another augmented reality view of the second user wearing the same item.

After block 610 I FIG. 6, method 600 can continue with a block 615 of transmitting the second 3D image to a third user via a third user device. Block 615 can be similar to block 415 (FIG. 4) in method 400 (FIG. 4) in certain aspects. Accordingly, as an example, the third user can be user 352 (FIG. 3), and the third user device can be user device 342 (FIG. 3). In some embodiments, the transmitting of block 615 can comprise sending a text with a link to the second 3D image in an augmented reality, as explained in further detail below with reference to FIGS. 9, 10, and 11.

In some embodiments of block 615, the third user device is capable of being connected to the same interactive digital space to which the second user device is connected. Also, where method 600 begins after method 400 (FIG. 4) begins, the interactive digital space of block 615 can be the same interactive digital space of block 410 (FIG. 4) and block 415 (FIG. 4) of method 400 (FIG. 4), but in other embodiments, the interactive digital space of method 600 is different from the interactive digital space of method 400 (FIG. 4). Furthermore, the third user device can have a viewer of the interactive digital space, and when the interactive digital space is an augmented reality, the viewer can be an augmented reality viewer. Accordingly, in this embodiment, block 615 can include transmitting the second 3D image to a third user via a third user device that is capable of being connected to the interactive digital space via an augmented reality viewer of the third user device.

In some embodiments, block 615 can transmit the second 3D image to multiple third users sequentially or simultaneously, each via their own respective user device that is capable of being connected to the same interactive digital space via a respective augmented reality viewer of the respective user device. For example, see the “Ask a friend” button in FIG. 8. Again, in embodiments where the augmented reality comprises a virtual reality or a mixed reality, etc., then the augmented reality viewer comprises a virtual reality viewer or a mixed reality viewer, etc., respectively.

Turning back to FIG. 6, in different embodiments, the third user of block 615 can be the first user of block 410 (FIG. 4) in method 400 (FIG. 4), and the third user device of block 615 can be the first user device of block 410 (FIG. 4) in method 400 (FIG. 4). In these embodiments, the second user creates the second 3D image of the second user wearing the 3D model of the same item, and then sends the second 3D image to the first user so that first and second users can see what each other looks like wearing the same item.

After block 615, method 600 can continue with a block 620 of receiving feedback regarding the second 3D image from the third user via the third user device. As an example, the feedback can be a vote in favor of the second 3D image, which means that the third user likes the item and/or the second user's wearing of the item. Block 620 can be similar to block 420 (FIG. 4) in method 400 (FIG. 4) in certain aspects. Accordingly, in some embodiments, before or after receiving the feedback in block 620, method 600 can be used to seek additional feedback from one or more other users in a similar manner to what is described with reference to blocks 615 and 620. The feedback in block 620 can be received form the second user in a synchronous manner with and/or in real-time with the transmission of the 3D image to the second user in block 615, and/or in an asynchronous manner with the transmission of the 3D image to the second user in block 615.

After block 620, method 600 can continue with a block 625 of storing the item in a database for the second user. In some embodiments, the item can be stored in the database so that the item can be added to a virtual shopping cart for the second user. Block 625 can be similar to block 425 (FIG. 4) in method 400 (FIG. 4) in certain aspects. Accordingly, in some embodiments, block 625 is performed before or simultaneously with block 620. In embodiments where block 610 receives instructions to create one or more second 3D images of the second user wearing 3D models of more than one item, then block 625 can comprise storing at least one of the more than one item in the database for the second user. In embodiments where method 600 begins after method 400 (FIG. 4) begins, the database of block 625 can be the same database of block 425 (FIG. 4) in method 400 (FIG. 4).

After block 625, method 600 can continue with an optional block 630 of storing the item in a virtual shopping cart of the second user. Block 630 can be similar to block 430 (FIG. 4) of method 400 (FIG. 4) in certain aspects. Accordingly, in embodiments where block 610 receives instructions to create one or more second 3D images of the second user wearing 3D models of more than one item and where block 625 stores at least one of the more than one item in the database for the second user, then block 630 can comprise storing the at least one of the more than one item in the virtual shopping cart for the second user.

As explained above, method 600 can be similar to method 400 (FIG. 4) in certain aspects. Based on the explanations herein, one skilled in the art will understand that the techniques explained herein can be further expanded in a similar manner. For example, the third user of method 600 can create another augmented reality view of the third user wearing the same item, and can transmit that view to a fourth user to seek feedback from the fourth user about the augmented reality view of the third user wearing the same item, and so on. Additional details of method 600 are explained with reference to FIGS. 9, 10, and 11, below.

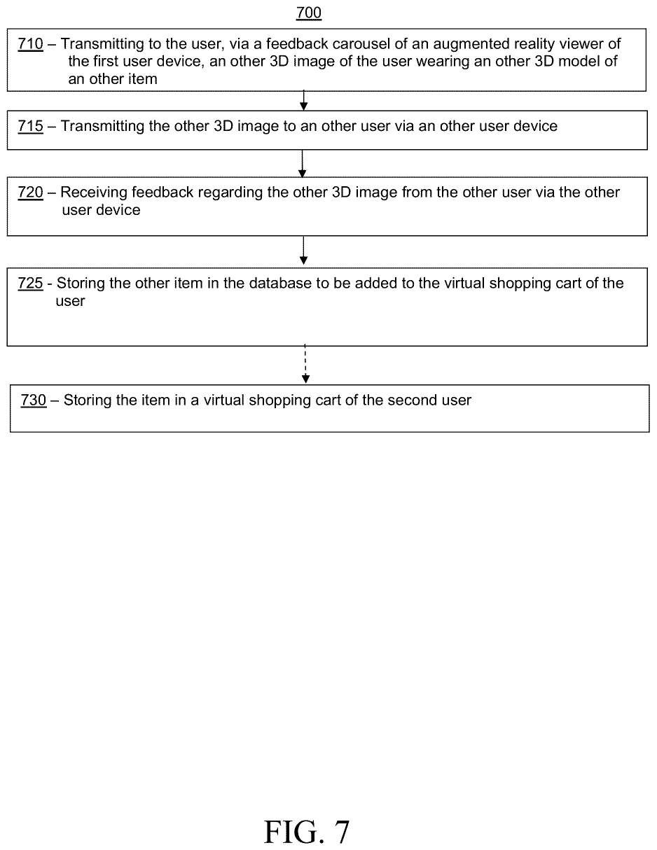

Turning to the next drawing, FIG. 7 illustrates a flow chart for a method 700 for augmented reality with feedback, which can provide both synchronous and asynchronous experiences, according to one embodiment. As explained below, in some embodiments, method 700 can be performed after method 400 (FIG. 4) begins but before method 400 (FIG. 4) finishes. Method 700 can be implemented via execution of computing instructions configured to run on one or more processors and stored on one or more non-transitory computer-readable media, and/or via one or more ASICs. Method 700 is merely an example and is not limited to the embodiments presented herein. Method 700 can be employed in many different embodiments or examples not specifically depicted or described herein.

In some embodiments, the procedures, the processes, the operations, the actions, and/or the activities of method 700 can be performed in the order presented. In other embodiments, the procedures, the processes, the operations, the actions, and/or the activities of method 700 can be performed in any suitable order. In still other embodiments, one or more of the procedures, the processes, the operations, the actions, and/or the activities of method 600 can be combined together or skipped.

In some embodiments, system 300 (FIG. 3) (including one or more of its elements, modules, and/or systems, such as communication system 311, storing system 312, converting system 313, digital display system 314, imaging system 315, and virtual cart system 316, etc.) can be suitable to perform method 700 and/or one or more of the operations, actions, and/or activities of method 700. In these or other embodiments, one or more of the operations, actions, and/or activities of method 700 can be implemented as one or more computing instructions configured to run on one or more processors and configured to be stored on one or more non-transitory computer readable media, and/or as one or more ASICs. Such non-transitory computer readable media can be part of a computer system such as system 300 (FIG. 3), web server 320 (FIG. 3), virtual shopping system 310 (FIG. 3), first user device 340 (FIG. 3), second user device 341 (FIG. 3), and third user device 342 (FIG. 3). The processor(s) can be similar or identical to the processor(s) described above with respect to computer system 100 (FIG. 1).

Referring to FIG. 7, in some embodiments, method 700 can include a block 710 of transmitting to the user, via a feedback carousel of the augmented reality viewer of the first user device, another 3D image of the user wearing another 3D model of another item. As an example, the user can be user 350 (FIG. 3), and the first user device can be user device 340 (FIG. 3).

When method 700 is performed after method 400 (FIG. 4) begins, block 710 can be performed after block 415 (FIG. 4) or after block 420 (FIG. 4) in method 400 (FIG. 4). In this embodiment, the user of block 710 can be the user of block 410 (FIG. 4) in method 400 (FIG. 4), and the first user device of block 710 can be the first user device of block 410 (FIG. 4) in method 400 (FIG. 4). Additionally, the augmented reality viewer of the first user device of block 710 can be the augmented reality viewer of the first user device of block 410 (FIG. 4) in method 400 (FIG. 4). In this embodiment, after the second user of block 415 (FIG. 4) in method 400 (FIG. 4) views the 3D image of the user wearing the 3D model of the item, the second user can create the other 3D image of the user wearing the other 3D model of the other item, and transmit that other 3D image to the user, so that the user can view the other 3D image and decide whether to add the 3D image to the feedback carousel of the augmented reality viewer of the first user device. In a different embodiment of block 710, the other 3D image of the user wearing the other 3D model of the other item can be automatically generated by the system based on the past purchases of the user or other items virtually tried-on by the user.

After block 710, method 700 can continue with a block 715 of transmitting the other 3D image to another user via another user device. Block 715 can be similar to block 415 (FIG. 4) in method 400 (FIG. 4) and block 615 (FIG. 6) in method 600 (FIG. 6) in certain aspects. Accordingly, as an example, the other user can be any of users 351 or 352 (FIG. 3) or another user (not shown in FIG. 3), and the other user device can be any of user devices 341 or 342 (FIG. 3) or another user device (not shown in FIG. 3). In some embodiments, the transmitting of block 715 can comprise sending a text with a link to the other 3D image in an augmented reality, as explained in further detail below with reference to FIGS. 9, 10, and 11.

In some embodiments of block 715, the other user device is capable of being connected to the same interactive digital space to which the first user device is connected. Also, where method 700 begins after method 400 (FIG. 4) begins, the interactive digital space of block 715 can be the same interactive digital space of block 410 (FIG. 4) and block 415 (FIG. 4) of method 400 (FIG. 4) and of block 610 (FIG. 6) and block 615 (FIG. 6) of method 600 (FIG. 6), but in other embodiments, the interactive digital space of method 700 is different from the interactive digital space of method 400 (FIG. 4) and of method 600 (FIG. 6). Furthermore, the other user device can have a viewer of the interactive digital space, and when the interactive digital space is an augmented reality, the viewer can be an augmented reality viewer. Accordingly, in this embodiment, block 715 can include transmitting the other 3D image to an other user via an other user device that is capable of being connected to the interactive digital space via an augmented reality viewer of the other user device.

In some embodiments, block 715 can transmit the other 3D image to multiple other users sequentially or simultaneously, each via their own respective user device that is capable of being connected to the same interactive digital space via a respective augmented reality viewer of the respective user device. For example, see the “Ask a friend” button in FIG. 8. Again, in embodiments where the augmented reality comprises a virtual reality or a mixed reality, etc., then the augmented reality viewer comprises a virtual reality viewer or a mixed reality viewer, etc., respectively.

Turning back to FIG. 7, after block 715, method 700 can continue with a block 720 of receiving feedback regarding the other 3D image from the other user via the other user device. As an example, the feedback can be a vote in favor of the other 3D image, which means that the other user likes the other item and/or the user's wearing of the other item. Block 720 can be similar to block 420 (FIG. 4) of method 400 (FIG. 4) and block 620 (FIG. 6) of method 600 (FIG. 6) in certain aspects. Accordingly, in some embodiments, before or after receiving the feedback in block 720, method 700 can be used to seek additional feedback from one or more additional other users in a similar manner to what is described with reference to blocks 715 and 720. The feedback in block 720 can be received form the second user in a synchronous manner with and/or in real-time with the transmission of the 3D image to the second user in block 715, and/or in an asynchronous manner with the transmission of the 3D image to the second user in block 715.

After block 720, method 700 can continue with a block 725 of storing the other item in a database for the user. In some embodiments, the other item can be stored in the database so that the other item can be added to a virtual shopping cart for the user. Block 725 can be similar to block 425 (FIG. 4) in method 400 (FIG. 4) and block 625 (FIG. 6) in method 600 (FIG. 6) in certain aspects. Accordingly, in some embodiments, block 725 is performed before or simultaneously with block 720. In embodiments where block 710 transmits to the user one or more other 3D images of the user wearing 3D models of more than one other item, then block 725 can comprise storing at least one of the more than one other item in the database for the user. In embodiments where method 700 begins after method 400 (FIG. 4) begins, the database of block 725 can be the same database of block 425 (FIG. 4) in method 400 (FIG. 4).

After block 725, method 700 can continue with an optional block 730 of storing the item in a virtual shopping cart of the second user. Block 730 can be similar to block 430 (FIG. 4) of method 400 (FIG. 4) and block 630 (FIG. 6) of method 600 (FIG. 6) in certain aspects. Accordingly, in embodiments where block 710 transmits to the user one or more other 3D images of the user wearing 3D models of more than one other item and where block 725 stores at least one of the more than one other item in the database for the user, then block 730 can comprise storing the at least one of the more than one other item in the virtual shopping cart for the user. Additional details of method 700 are explained with reference to FIGS. 9, 10, and 11, below.

Relating FIGS. 4, 5, 6, and 7 to other aspects of FIG. 3, in various embodiments, communication system 311, can perform all or a portion of blocks 410 (FIGS. 4), 415 (FIGS. 4), 420 (FIGS. 4), 515 (FIGS. 5), 610 (FIGS. 6), 615 (FIGS. 6), 620 (FIGS. 6), 710 (FIGS. 7), 715 (FIG. 7), and 720 (FIG. 7). Similarly, storing system 312 can perform all or a portion of blocks 410 (FIGS. 4), 420 (FIGS. 4), 425 (FIGS. 4), 430 (FIGS. 4), 515 (FIGS. 5), 610 (FIGS. 6), 620 (FIGS. 6), 625 (FIGS. 6), 630 (FIGS. 6), 710 (FIGS. 7), 720 (FIGS. 7), 725 (FIG. 7), and 730 (FIG. 7). Furthermore, converting system 313 can perform all or a portion of block 510 (FIG. 5). Additionally, digital display system 314 can perform all or a portion of blocks 410 (FIGS. 4), 415 (FIGS. 4), 420 (FIGS. 4), 430 (FIGS. 4), 610 (FIGS. 6), 615 (FIGS. 6), 620 (FIGS. 6), 630 (FIGS. 6), 710 (FIGS. 7), 715 (FIGS. 7), 720 (FIG. 7), and 730 (FIG. 7). Moreover, imaging system 315 can perform all or a portion of blocks 410 (FIGS. 4), 610 (FIG. 6), and 710 (FIG. 7) Also, virtual cart system 316 can perform all or a portion of blocks 430 (FIGS. 4), 630 (FIG. 6), and 730 (FIG. 7).

Turning further ahead in the drawings, FIGS. 9, 10, and 11 illustrate flow charts for different portions of a method 900 for augmented reality with feedback, which can provide both synchronous and asynchronous experiences, according to one embodiment. As explained below, method 900 can be similar to a combination of method 400 (FIG. 4), method 500 (FIG. 5), method 600 (FIG. 6), and method 700 (FIG. 7) in certain aspects. Method 900 can be implemented via execution of computing instructions configured to run on one or more processors and stored on one or more non-transitory computer-readable media, and/or via one or more ASICs. Method 900 is merely an example and is not limited to the embodiments presented herein. Method 900 can be employed in many different embodiments or examples not specifically depicted or described herein.

In some embodiments, the procedures, the processes, the operations, the actions, and/or the activities of method 900 can be performed in the order presented. In other embodiments, the procedures, the processes, the operations, the actions, and/or the activities of method 900 can be performed in any suitable order. In still other embodiments, one or more of the procedures, the processes, the operations, the actions, and/or the activities of method 900 can be combined together or skipped.

In some embodiments, system 300 (FIG. 3) (including one or more of its elements, modules, and/or systems, such as communication system 311, storing system 312, converting system 313, digital display system 314, imaging system 315, and virtual cart system 316, etc.) can be suitable to perform method 900 and/or one or more of the operations, actions, and/or activities of method 900. In these or other embodiments, one or more of the operations, actions, and/or activities of method 900 can be implemented as one or more computing instructions configured to run on one or more processors and configured to be stored on one or more non-transitory computer readable media, and/or as one or more ASICs. Such non-transitory computer readable media can be part of a computer system such as system 300 (FIG. 3), web server 320 (FIG. 3), virtual shopping system 310 (FIG. 3), first user device 340 (FIG. 3), second user device 341 (FIG. 3), and third user device 342 (FIG. 3). The processor(s) can be similar or identical to the processor(s) described above with respect to computer system 100 (FIG. 1).

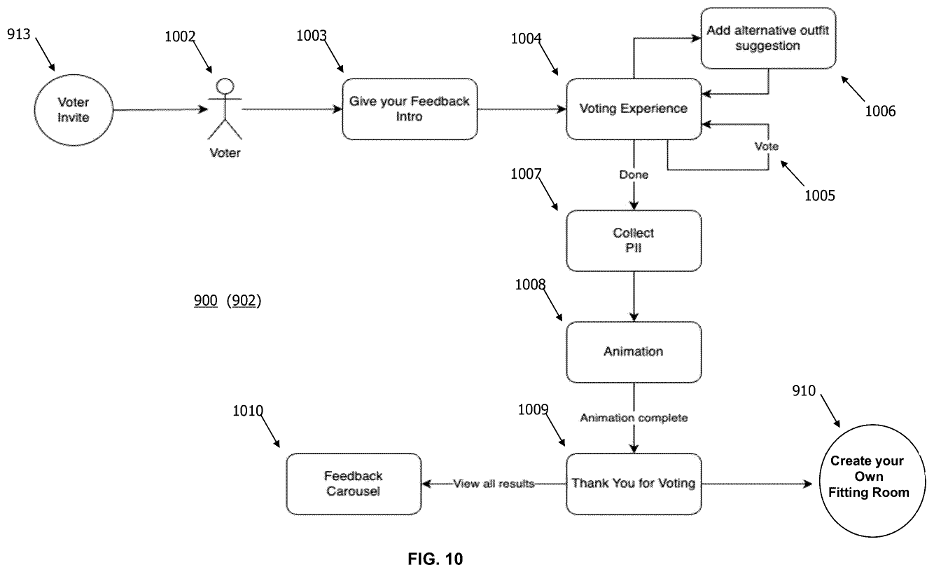

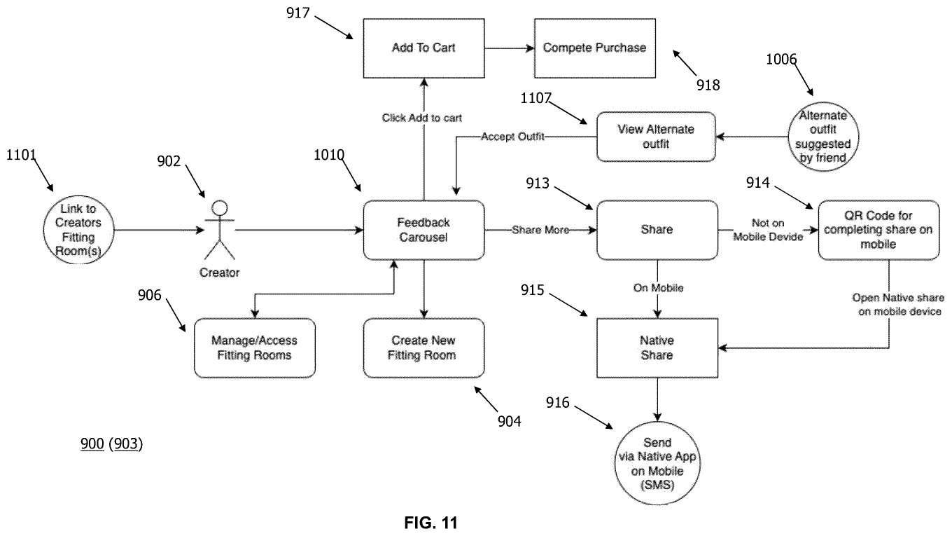

In some embodiments, FIG. 9 shows a first portion of a method 900 (or a method 901), which can be referred to as a creator flow diagram; FIG. 10 shows a second portion of a method 900, which can be referred to as a voter flow diagram; and FIG. 11 shows a third portion of a method 900, which can be referred to as a feedback flow diagram, although FIGS. 9 and 10 also show aspects of feedback, as well. Referring specifically to FIG. 9, in some embodiments, the first portion of method 900 can include a call to action or invitation 901, which can be sent to, activated by, or otherwise initiated by a creator 902. As an example, creator 902 can be the same as user 350 (FIG. 3), and creator 902 can use an app on first user device (e.g., user device 340 (FIG. 3)) to perform the call to action or invitation 901 and many of the other steps in method 900. After initiating method 900, creator 902 can use the app to get started 903 by creating 910 a fitting room 904. Within the fitting room 904, creator 902 can virtually try-on one or more items, as explained below with respect to fitting room 904. An example of a fitting room is depicted in FIG. 8.

Turning back to FIG. 9, to be able to virtually try one an item, the system (e.g., system 300 (FIG. 3) and/or virtual shopping system 310 (FIG. 3)) can create (1) a 3D model of the item to be virtually tried on and (2) a 3D image of the user. To create a 3D model of the item, the system can receive one or more 2D images (e.g., photographs) of an item, such as a pair of sunglasses, and the system can transform those one or more 2D images into one or more 2D models, and then convert the one or more 2D models into a 3D model of the item.

To create a 3D image of the user, creator 902 can choose a preexisting model (e.g., choose your own model) 907 to represent creator 902, where preexisting model 907 can match the height and clothing size of creator 902. In a different embodiment, to create a 3D image of the user, creator 902 can be the creator's own model 908 by creating one or more scans or photographs of the creator's body or a portion of the creator's body (e.g., the creator's face), which the system can first transform into one or more 2D models and then convert the one or more 2D models into a 3D image of the creator's body or a portion of the creator's body. In another embodiment, instead of choosing your own model 907 or being your own model 908, creator 902 can use a live feed 909, which can include creator 902 recording one or more photographs or videos of creator 902 physically wearing the item.

After creating a 3D image of creator 902 and creating a fitting room 910, creator 902 can use fitting room 904 to virtually try-on one or more items in one or more augmented reality views. The augmented reality views can be to create a look for creator 902 for different occasions, such as outfits for a bridal party. The augmented reality views can be for a single look and/or can be a collage of looks.

Fitting room 904 can be organized by category 905 of items to be virtually tried-on by creator 902. As an example, the categories can include eyewear, cosmetics and other beauty products, shirts and other tops, pants, dresses, shoes, and accessories (such as jewelry, scarfs, hats, etc.). As a further example, the category of eyewear can include sunglasses, reading glasses, etc. The category 905 of items to be virtually tried on in fitting room 904 by creator 902 can be changed and refreshed by creator 902. Creator 902 also can manage 906 fitting room 904, including controlling which other users (if any) of the system have access to fitting room 904 of creator 902.

After creator 902 has created one or more augmented reality views of creator 902 virtually trying-on the one or more items or combinations of the one or more items, creator 902 can save the outfit and ask a friend 911 for feedback regarding the one or more augmented reality views of creator 902 virtually trying-on the one or more items or combinations of the one or more items. As an example, the friend (e.g., user 351 (FIG. 3)) can vote in favor of, or not in favor of, the one or more items worn by creator 902 in the one or more augmented reality views, where the vote is the feedback provided to creator 902.

For the friend to provide the feedback, the system (e.g., system 300 (FIG. 3) and/or virtual shopping system 310 (FIG. 3)) can receive or collect 912, from creator 903, contact information about the friend, such as the friend's name and the friend's mobile telephone number. As a first example, creator 902 can submit to the system the name and the mobile phone number of the friend, and creator 902 can share 913 with the friend the augmented reality views of creator 902 virtually trying-on the one or more items by having the system use the mobile phone number to text to the friend a link to the augmented reality views of creator 902. The friend can click on the link to bring the friend to a mobile application (app) on a second user device (e.g., user device 341 (FIG. 3)) implementing method 900 (i.e., native share 915) so that the friend can provide the feedback 916 to creator 902 through the app on the second user device. As a second example, creator 902 can share 913 the one or more augmented reality views with the friend by sharing a quick response (QR) code 914 generated by the system and scanned in by the friend using the second user device to bring the friend to the app on the second user device implementing method 900 (i.e., native share 915) so that the friend can provide the feedback 916 to creator 902 through the app on the second user device. As a third example, creator 902 can identify the user name of the friend in the system and connect directly with the friend through the system, such that the system can send the augmented reality views to the friend through the system (i.e., native share 915), and where the friend can provide feedback 916 to creator 902 through the app on the second user device.

After receiving the feedback, which is described in more detail in FIGS. 10 and 11 below, creator 902 (back in FIG. 9) can add the one or more of the items to a virtual shopping cart 917, where the items were tried-on by creator 902 in the augmented reality views and voted on by one or more friends of creator 902. Creator 902 can view the virtual shopping cart 920 and checkout or purchase 918 the one or more of the items, and as needed, creator 902 can login 919 to the system or app on the first user device to be able to checkout or purchase 918 the one or more of the items.

Turning to FIG. 10, the second portion of method 900 (or a method 902) begins with the voter invitation from creator 902 (FIG. 9) to share 913 the augmented reality views of creator 902 to the friend or voter 1002. As noted above with respect to FIG. 9, the friend or voter 1002 in FIG. 10 can be the same as user 351 (FIG. 3), and the friend or voter 1002 can use the app on the second user device (e.g., user device 341 (FIG. 3)) to implement certain steps in this second portion of method 900. Through the app on the second user device, the friend or voter 1002 can give an introduction to the feedback 1003, and can go through the voting experience 1004, which can include voting 1005 for the item virtually tried-on by creator 902 and/or suggesting 1006 a different item for the creator 902 (FIG. 9) to purchase. The suggestion can include generating a new 3D image of the creator 902 wearing a 3D model of the different item, which can be added to a feedback carousel 1010 for creator 902, as explained below. The vote of the friend or voter 1002 also is added to feedback carousel 1010, as explained below.

After the voting experience 1004, the friend or voter 1002 can optionally provide additional PII 1007 of the friend or voter 1002 to the system (e.g., system 300 (FIG. 3) and/or virtual shopping system 310 (FIG. 3)), and optionally create an animation 1008 for creator 902 (FIG. 9). The system can thank the friend or voter 1002 for voting 1009, and then the friend or voter 1002 can (1) view the feedback carousel 1010 to see the vote(s) and suggestion(s) of the friend or voter 1002 and/or of other friends or voters of creator 902 (FIGS. 9) and/or (2) create a new fitting room 910 for the friend or voter 1002 to virtually try-on the same item and/or different items and to seek feedback from friends or voters of the friend or voter 1002 regarding such items.

Next, turning to FIG. 11, the third portion of method 900 (or a method 903) can optionally begin with a link to the fitting room 1101 of the creator 902. Creator 902 can use the app to view the feedback carousel 1010, which includes feedback from the friends or voters from whom creator 902 requested feedback, as explained above with reference to FIG. 10. The feedback includes votes from the friends or voters of creator 902, as well as suggestions 1006 from the friends or voters for one or more different items for creator 902 to purchase. Creator 902 can view the suggested items or outfits 1107 before deciding whether to add them to feedback carousel 1010 to request additional votes from other friends. After viewing the feedback in feedback carousel 1010, creator 902 can (1) create a new fitting room 904 based on one of the suggestions contained in feedback carousel 1010, and/or (2) manage 906 the existing fitting room(s) of creator 902, including controlling which other users (if any) of the system have access to the fitting room(s) of creator 902. Furthermore, after viewing the feedback in feedback carousel 1010, creator 902 can share 913 the augmented reality views with additional friends or voters using any of the different sharing options described above with reference to FIG. 9, including sharing through a QR code 914 and/or sharing directly through a native share 915 via the app, and the feedback 916 can be sent back to creator 902 via the app. Additionally, after viewing the feedback in feedback carousel 1010, creator 902 also can add one or more of the items virtually worn by creator 902 in feedback carousel 1010 into a virtual shopping cart 917 and check out or complete a purchase 918 of the one or more of the items in the virtual shopping cart. Feedback carousel 1010 permits creator 902 and the friends or voters of creator 902 to collaborate and create group outfits, such as a bridal party coordinating outfits for a wedding, all of which can be done synchronously or asynchronously.

In a number of embodiments where one or more ML/AI models are used (such as in block 410 (FIG. 4), block 510 (FIG. 5), block 515 (FIG. 5), block 610 (FIG. 6), and block 710 (FIG. 7)), method 400 (FIG. 4), method 500 (FIG. 5), method 600 (FIG. 6), and method 700 (FIG. 7) further can include pre-training and/or re-training the trained ML/AI models based upon the feedback received from a system user or collected from various data sources, and/or synthesized training data. In these embodiments, the same or different ML/AI models can be used in one or more of the above-referenced blocks.

For each of the machine learning models to be retrained, the respective training datasets can be updated manually by a system user (e.g., an ML engineer, a data scientist, etc.) and/or automatically by a system (e.g., system 300 (FIG. 3) and/or virtual shopping system 310 (FIG. 3)). The system user can select new training data from various data sources (e.g., websites, product catalogs, private third-party databases, etc.). The system can collect new training data based upon various criteria. In certain embodiments, historical input and/or output data of the model to be retrained can be used for re-training the model. In several embodiments, the historical input and/or output data of the model can be selected based upon system performance and/or user feedback from the system user associated with the historical output data. Examples of the user feedback can include when the machine learning model incorrectly classifies whether a user is a current driver of a vehicle, and so forth. In various embodiments, when more than one training dataset is used for the pre-training and/or re-training, the system (e.g., system 300 (FIG. 3) and/or virtual shopping system 310 (FIG. 3)) can format or re-format the data of the more than one training dataset (especially when datasets are from different sources) so that the hierarchy, schema, and/or other aspects of the data of the more than one training dataset follow a common hierarchy, structure, schema, etc., and so that the data of the more than one training dataset can be more easily used to pre-train or re-train the one or more machine learning models. The system can pre-determine the common hierarchy, structure, schema, etc. As needed, the system can reformat the data from various training dataset into a common data format so that the data can be used properly and efficiently by the system.

In some embodiments, the machine learning models, AI algorithms, classifiers, etc. can be customized and/or fine-tuned for the user. For example, the customized classifiers for the above-referenced blocks can be trained, retrained, and stored locally on virtual shopping system 310 (FIG. 3). As another example, one or more of these customized classifiers can be trained and/or retrained remotely and stored locally (e.g., at virtual shopping system 310). In these examples, the classifiers can be customized to the user wearing a pair of sunglasses, makeup, a hat, a shirt, a pair of pants, a jacket, one or more accessories, and so on.

Examples of the algorithms used for the various ML/AI models for one or more of the above-mentioned procedures, processes, activities, actions, operations, and/or methods can include BERT (Bidirectional Encoder Representations from Transformers), LLM (Language Learning Models), Lambda, Palm, XLNet, GPT-3 (generative pre-training transformer), GPT-4, KNN (k-nearest neighbor), decision trees, linear regression, logistic regression, K-Means, neural networks, fuzzy logic, GANs (generative adversarial networks), CTGAN (cloud transformer generative adversarial networks), CNNs (convolutional neural networks), VAEs (variational autoencoder), and so forth. In various embodiments, each of the ML/AI models used can be trained and/or retrained dynamically and/or regularly.

In some embodiments, the systems and/or methods can be configured to train or re-train the one or more ML/AI models. The training of each of the ML/AI models can be supervised, semi-supervised, and/or unsupervised - which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In some embodiments, the trained and/or retrained ML/AI model as well as the training datasets can be stored in, updated, and accessed from a database. In the same or different embodiments, when more than one training dataset is used for the pre-training and/or re-training, the data of the more than one training dataset can be formatted or reformatted so that the hierarchy, schema, and/or other aspects of the data of the more than one training dataset (especially when datasets are from different sources) follow a common hierarchy, structure, schema, etc., and so that the data of the more than one training dataset can be more easily used to pre-train or re-train the one or more machine learning models. In some embodiments, the common hierarchy, structure, schema, etc. can be predetermined.

In some embodiments, the users, systems, and/or methods further can determine whether to add the newly created historical input and/or output data to the training dataset for retraining the ML/AI models based upon user feedback and/or predetermined criteria. The user feedback can be associated with the output data of the ML/AI models or the output of the systems and/or methods using the ML/AI models.

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

Although systems and methods for collecting data have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting. For example, the systems, methods, and non-transitory computer readable storage media disclosed herein can be to create augmented reality views of 3D image of a room with 3D models of one or more pieces of furniture, where the furniture can be purchased through the system and where such augmented reality views can be shared with the creator's friends, who can provide feedback on such views or pieces of furniture via the system in an asynchronous (or synchronous) manner. In other use cases, an influencer can create a set of looks and share them with followers to determine the best look based on votes from the followers, and the followers can re-dress or change the look through the system. In further use cases, a retailer can create an affiliate program through the system for revenue sharing.

It is intended that the scope of the disclosure shall be limited only to the extent required by the appended claims. For example, to one of ordinary skill in the art, it will be readily apparent that any element of FIGS. 1-11 can be modified, and that the foregoing discussion of certain of these embodiments does not necessarily represent a complete description of all possible embodiments. Additionally, one or more of the procedures, processes, operations, actions, and/or activities of the method in FIGS. 4-7 and 9-11 can include different procedures, processes, actions, and/or activities and be performed by many different modules, in many different orders. As an example, the modules, models, elements, and/or systems within system 300 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM (erasable programmable read-only memory) memory, EEPROM (electrically erasable programmable read-only memory) memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
a processor; and
a non-transitory computer-readable media storing computing instructions that, when executed on the processor, causes the processor to execute operations comprising:
receiving, from a user via a first user device, instructions to create a 3D image of the user wearing a 3D model of an item within an interactive digital space via an augmented reality viewer of the first user device;
transmitting the 3D image to a second user via a second user device that is capable of being connected to the interactive digital space via an augmented reality viewer of the second user device;
receiving feedback regarding the 3D image from the second user via the second user device; and
storing the item in a database for the user.

2. The system of claim 1, wherein the system provides an asynchronous experience for the user and the second user.

3. The system of claim 1, wherein the operations further comprise at least one of:
converting a 2D model of the item into the 3D model of the item; or importing the 3D model into the interactive digital space to be displayed to the user via the augmented reality viewer of the first user device.

4. The system of claim 1, wherein the operations further comprise:
storing the item in a virtual shopping cart of the user.

5. The system of claim 1, wherein the operations further comprise:
receiving instructions of the second user from the second user device to create a second 3D image of the second user wearing the 3D model of the item within the interactive digital space via the augmented reality viewer of the second user device.

6. The system of claim 5, wherein the operations further comprise:
transmitting the second 3D image to a third user via a third user device that is capable of being connected to the interactive digital space of via an augmented reality viewer of the third user device.

7. The system of claim 6, wherein the operations further comprise:
receiving feedback regarding the second 3D image from the third user via the third user device.

8. The system of claim 7, wherein the operations further comprise:
storing the item in the database to be added to a virtual shopping cart of the second user.

9. The system of claim 1, wherein the operations further comprise:
transmitting to the user, via a feedback carousel of the augmented reality viewer of the first user device, an other 3D image of the user wearing an other 3D model of an other item.

10. The system of claim 9, wherein the operations further comprise:
transmitting the other 3D image to an other user via an other user device that is capable of being connected to the interactive digital space via an augmented reality viewer of the other user device;
receiving feedback regarding the other 3D image from the other user via the other user device; and
storing the other item in the database for the user.

11. A computer-implemented method comprising:
receiving, from a user via a first user device, instructions to create a 3D image of the user wearing a 3D model of an item within an interactive digital space via an augmented reality viewer of the first user device;
transmitting the 3D image to a second user via a second user device that is capable of being connected to the interactive digital space via an augmented reality viewer of the second user device;
receiving feedback regarding the 3D image from the second user via the second user device;
storing the item in a database for the user; and
receiving instructions of the second user from the second user device to create a second 3D image of the second user wearing the 3D model of the item within the interactive digital space via the augmented reality viewer of the second user device.

12. The computer-implemented method of claim 11, wherein the method provides an asynchronous experience for the user and the second user.

13. The computer-implemented method of claim 12 further comprising at least one of:
converting s 2D model of the item into the 3D model of the item; or importing the 3D model into the interactive digital space to be displayed to the user via the augmented reality viewer of the first user device.

14. The computer-implemented method of claim 11 further comprising:
storing the item in a virtual shopping cart of the user.

15. The computer-implemented method of claim 11 further comprising:
transmitting the second 3D image to a third user via a third user device that is capable of being connected to the interactive digital space of via an augmented reality viewer of the third user device.

16. The computer-implemented method of claim 15 further comprising:
receiving feedback regarding the second 3D image from the third user via the third user device.

17. The computer-implemented method of claim 16 further comprising:
storing the item in the database to be added to a virtual shopping cart of the second user.

18. The computer-implemented method of claim 11 further comprising:
transmitting to the user, via a feedback carousel of the augmented reality viewer of the first user device, an other 3D image of the user wearing an other 3D model of an other item.

19. The computer-implemented method of claim 18 further comprising:
transmitting the other 3D image to an other user via an other user device that is capable of being connected to the interactive digital space via an augmented reality viewer of the other user device;
receiving feedback regarding the other 3D image from the other user via the other user device; and
storing the other item in the database for the user.

20. A non-transitory computer-readable medium storing computing instructions that, when executed on a processor, cause the processor to execute operations comprising:
receiving, from a user via a first user device, instructions to create a 3D image of the user wearing a 3D model of an item within an interactive digital space via an augmented reality viewer of the first user device;
transmitting the 3D image to a second user via a second user device that is capable of being connected to the interactive digital space via an augmented reality viewer of the second user device;
receiving feedback regarding the 3D image from the second user via the second user device;
storing the item in a database for the user;
receiving instructions of the second user from the second user device to create a second 3D image of the second user wearing the 3D model of the item within the interactive digital space via the augmented reality viewer of the second user device; and
transmitting the second 3D image to a third user via a third user device that is capable of being connected to the interactive digital space via an augmented reality viewer of the third user device.
